(19) United States
(12) Patent Application Publication
(10) Pub. No.: US 2022/0253873 A1
(43) Pub. Date: Aug. 11, 2022

(54) BALANCING OF TERRITORIES FOR MARKETING AND SALES AND A METHOD THEREOF

(71) Applicant: Cozmix, Inc., Lake Mary, FL (US)

(72) Inventor: Stephen Maughan, Longwood, FL (US)

(21) Appl. No.: 17/716,721

(22) Filed: Apr. 8, 2022

Related U.S. Application Data
(60) Provisional application No. 63/147,926, filed on Feb. 10, 2021.

(51) Int. Cl. G06Q 30/02; G06F 3/04812; G06F 3/0488

(52) U.S. Cl. CPC G06Q 30/0201; G06F 3/0488; G06F 3/04812

(57) ABSTRACT

A system allows a user to balance sales territories for marketing and sales purposes. The system allows a user to select geographical areas that need to be balanced. The user selects an area and, by moving a finger or cursor, adds additional sales territories to be balanced. When the appropriate sales territories have been selected, the user lifts the finger or releases a button on the mouse to automatically balance the selected sales based on at least one balancing criteria to create a group of balanced territories. By also using a predetermined key during the selection of the sales territories, the same criteria of the previous balancing is again used.

### REFERENCE TO RELATED CASE

This application claims priority under 35 U.S.C. § 119 (e) to provisional application No. 63/147,926, filed on Feb. 10, 2021, which is hereby incorporated by reference in its entirety.

### BACKGROUND OF THE INVENTION

### Field of the Invention

The present invention relates to a system and a method of balancing territories for marketing and sales purposes. Sales territories (for sales, service, franchising, etc.) may be made and assigned based on information known at the time of the assignments. The sales territories may become skewed as populations move and change. They may also be affected by technology (virtual meetings rather than in-person meetings) and the products that are available. Occasionally, the sales territories may need to be re-aligned or balanced because some sales territories may have grown too large and others may have become smaller (based on any number of criteria).

Thus, the present invention allows for the automatic balancing of a number of sales territories areas using only a mouse or pointer.

### Summary of the Invention

The present invention is directed to a sales territory system that includes at least one computer processor, a display coupled to the at least one computer processor, an input device for communication with the at least one computer processor and the display, and a memory coupled to the at least one computer processor, the sales territory balancing system is configured for displaying on the display a geographic area, the geographic area comprising a plurality of predefined areas, and the geographic area is also divisible into a plurality of sales territories, wherein each of the plurality of sales territories includes a plurality of the predefined areas, and adjusting at least some of the plurality of sales territories in response to a user selecting a first sales territory with a pointer and then moving the pointer through a plurality of sales territories to another portion of the geographic area, whereby the plurality of sales territories pointed to by the user are automatically balanced based on at least one balancing criteria to create a group of balanced territories after selection of the plurality of the sales territories.

In some embodiments, the predefined areas correspond to areas selected from the group of postal codes, zip codes, telephone area codes, county boundaries, municipal boundaries, and congressional boundaries.

In some embodiments, the at least one balancing criteria includes sales volume, number of sales calls, the number of accounts, the number of territories, and the compactness of the sales territories.

In some embodiments, each of the sales territories in the group of balanced territories has a value based on the at least one balancing criteria and the values of each of the sales territories in the group of balanced territories are within a predetermined range.

In some embodiments, the at least one balancing criteria is used in a subsequent balancing of territories when a predetermined key associated with the at least one computer processor is selected during the movement of the pointer.

In other embodiments, the adjusting of the plurality of sales territories uses balancing technology.

In yet another aspect, the present invention is directed to a method of balancing sales territories that includes selecting at least one of a plurality of predefined areas with a pointer on a display coupled to at least one computer processor, the plurality of predefined areas being located in a geographic area and wherein the geographic area is also divisible into a plurality of sales territories and each of the plurality of sales territories includes a plurality of the predefined areas, moving the pointer within the geographic area from a first sales territory in the plurality of sales territories through the geographic area to select a group of sales territories, wherein the group of selected sales territories selected by the user are automatically balanced based on at least one balancing criteria to create a group of balanced territories after selection of the sales territories.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is schematic of a one embodiment of a system according to the present invention;

FIG. 2 is a flowchart showing the use of the system to automatically balance sales territories;

FIG. 3 is a representation of a screen of the system illustrating the geographic area, territories, and predefined areas according to one embodiment of the present invention;

FIG. 4 is a representation of the geographic area of FIG. 3 illustrating the selection of predefined areas to be balanced;

FIG. 5 is a representation of the geographic area of FIG. 3 illustrating the balanced sales territories after the selected predefined areas have been automatically balanced;

FIG. 6 is a screen shot of the choices available for the balancing criteria for a particular balancing technology;

FIG. 7 is a screen shot of the options available for the balancing technology with regard to the depth of the optimization;

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

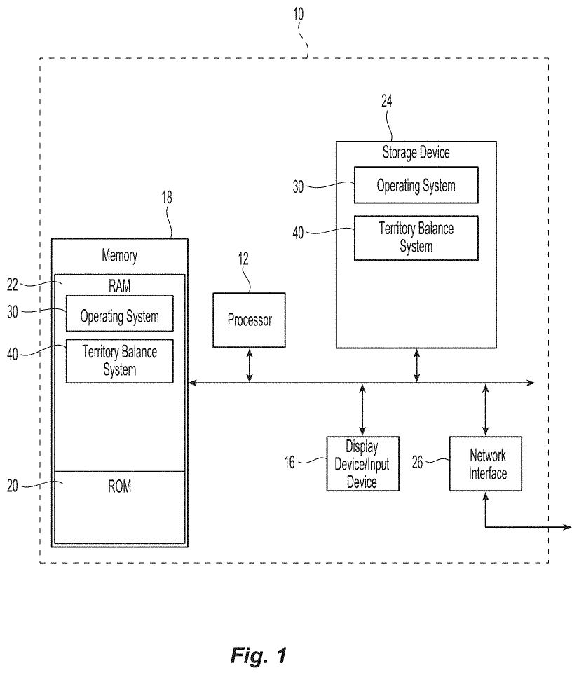

FIG. 1 is a schematic of one embodiment of a system 10 according to the present invention. As may be understood the system 10 includes a processor 12 that communicates with other elements within the system 10 via a system interface or bus system 14. Also included in the system 10 is a display device/input device 16 for receiving and displaying data. This display device/input device 16 may be, for example, a keyboard, a touch-sensitive screen, or a pointing device that is used in combination with a monitor. The system 10 further includes memory 18, which preferably includes both read only memory (ROM) 20 and random access memory (RAM) 22. The system's ROM 20 is used to store appropriate systems that help to transfer information between elements within the system 10.

In addition, the system 10 includes at least one storage device 24, such as a flash drive, a hard disk drive, a floppy disk drive, a CD Rom drive, or optical disk drive for storing information on various computer-readable media, such as a hard disk, a removable magnetic disk, or a CD-ROM disk. As will be appreciated by one of ordinary skill in the art, each of these storage devices 24 is connected to the system bus 14 by an appropriate interface. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 22. Such program modules include an operating system 30 and the territory balancing system 40, as well as possible geographic programs as well. As described in more detail below, the territory balancing system 40 controls certain aspects of the operation of the system 10 with the assistance of the processor 12 and an operating system 30.

Also located within the system 10 is a network interface 26, for interfacing and communicating with other elements of a computer network if so desired. It will be appreciated by one of ordinary skill in the art that one or more of the system 10 components may be located geographically remotely from other system 10 components. Furthermore, one or more of the components may be combined, and additional components performing functions described herein may be included in the system 10.

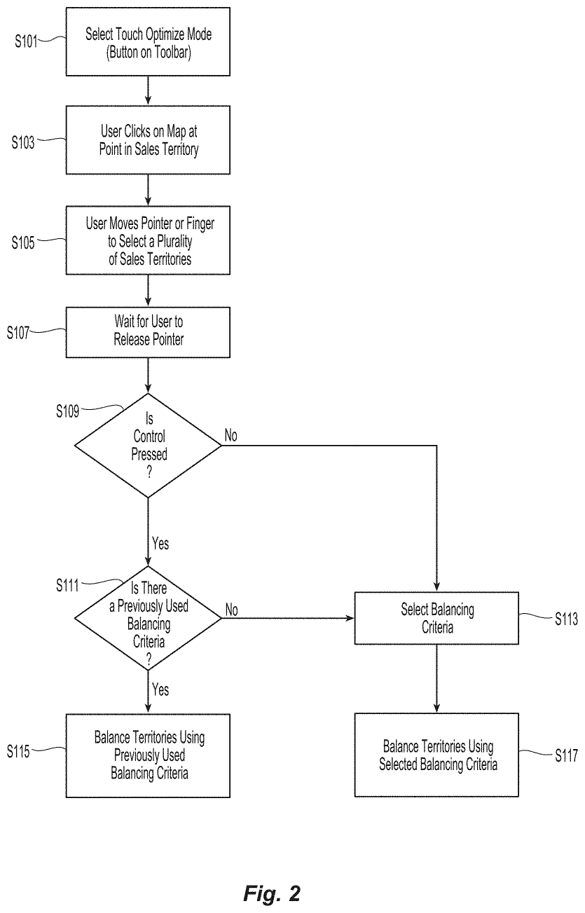

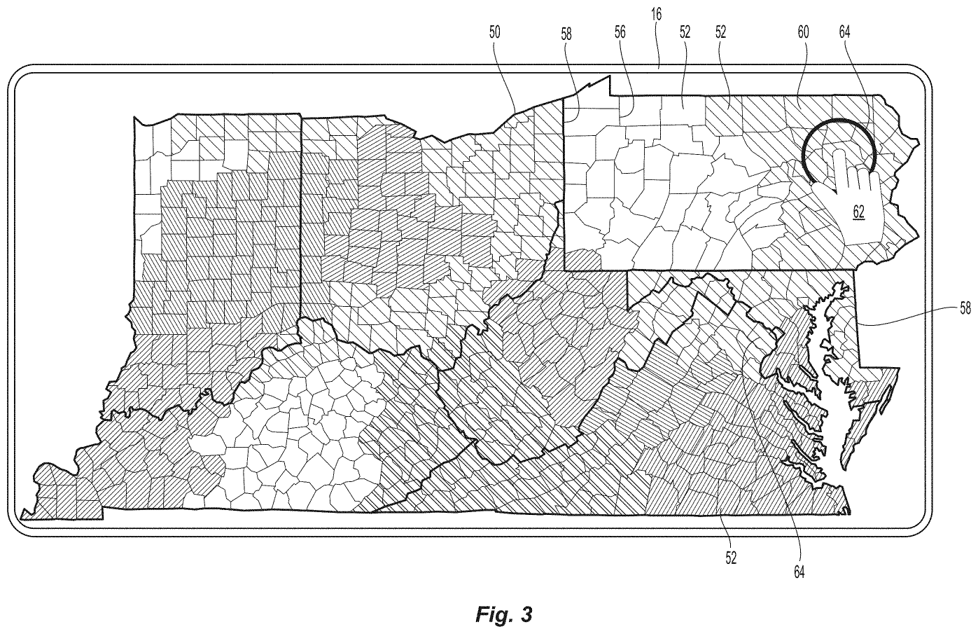

The operation of one embodiment of the system 10 is described in conjunction with the flowchart illustrated in FIG. 2 and the maps in FIGS. 3-5. The system 10 displays on a display, such as the device/input device 16, a geographic area 50. A representation of the geographic area 50 is illustrated in FIGS. 3-5. The geographic area 50 is used to assign sales territories 54 to sales people, account managers, account representatives, franchise territories, service territories, or for any other purpose where geographic areas are divided up and assigned. Thus, the geographic area 50 may be any geographic area, including but not limited to states, countries, territories, continents, or portions thereof. The geographic area 50 is then preferably divided up into smaller predefined areas 52. The predefined areas 52 can be defined by postal codes, zip codes, telephone area codes, county boundaries, municipal boundaries, and/or congressional boundaries. Sales territories 54 are in turn defined by the predefined areas 52 that are assigned according to one of the purposes noted above. The sales territories 54 are usually defined by more than one of the predefined areas 52, but the sales territories 54 may also be a single predefined area 52. Additionally, several of the predefined areas 52 illustrated in FIG. 3 may be combined to redefine one of the predefined areas 52. For example, several zip codes or area codes may be logically grouped together to create a predefined area 52 for the purposes of this invention.

The predefined areas 52 or geographic area 50 may also be divided into other sub-geographic territories or groupings. For example, the predefined areas 52 may be grouped to make sub-geographic entities such as states, counties, municipalities, boroughs, etc., which are smaller than the geographic area 50 but at least as large as one of the predefined areas 52.

Referring back to FIG. 3, a geographic area 50 (or a portion of a geographic area) is illustrated in the display. The lighter lines 56 and the darker lines 58 are visible, with the lighter lines 56 defining zip codes in the embodiment illustrated, and the darker lines 58 defining states. Sales territories 54 (5 labeled territories 54a, 54b, 54c, 54d, 54e in the figures) are illustrated in FIGS. 3-5 by the hatching of the sales territories and the predefined areas 52 within those territories.

A pointer 62 is used to identify a sales territory 54 of interest, e.g. a first sales territory 54a that, in additional to other sales territories, needs to be balanced. The pointer 62 is illustrated as a finger icon in FIGS. 3-5, but could be any appropriate indicia, such as an arrow, a finger as illustrated or a personalized pointer, etc. As seen in FIGS. 3-5, the pointer 62 may also have a predetermined radius 64 around the pointer 62 and any predefined areas 52 that are at least partially within the radius 62 as the user moves the pointer 62 will be included in the group of sales territories 54. The radius 64 may be adjustable, depending on the user's preference and the zoom factor on the geographic area 50. Or there may not be a radius 64 at all.

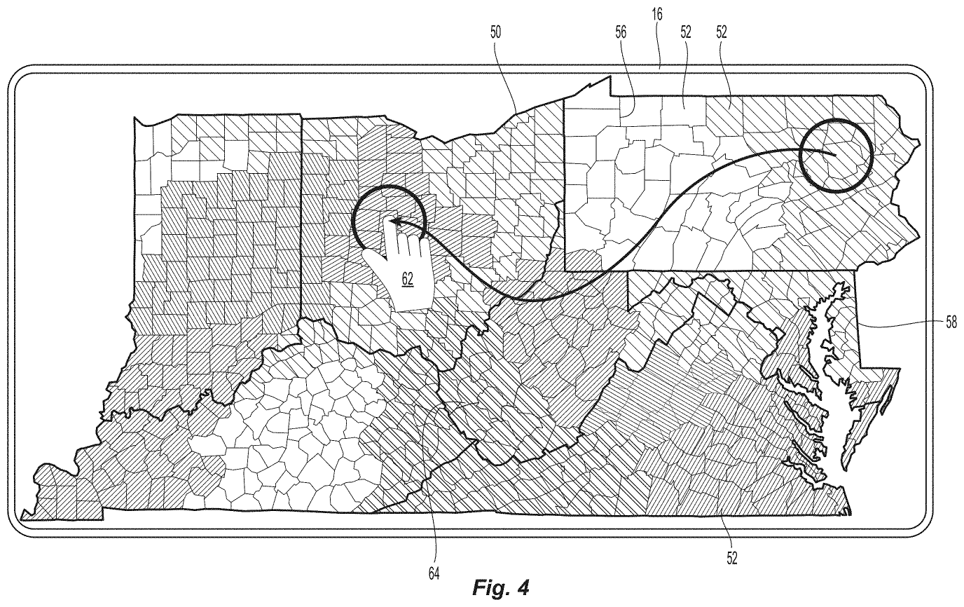

To balance a plurality of sales territories 54, the user selects the territory balance system 40 in Step S101 (and the touch optimize mode in particular). Then, according to step S103 in FIG. 2, the user moves the pointer 62 to any of the sales territories 54 of interest, such as sales territory 54b in FIG. 3 and left clicks on the mouse (if there is one), or if on a touch-screen device (i.e., a tablet, touch screen monitor, etc.) the user simply holds their finger, stylus, etc., on the screen 16. Then as illustrated at step S105 and in FIG. 4, the user moves the pointer 62 through the predefined areas 52 that are to be included in the plurality of sales territories 54 to be balanced—such as sales territories 54a, 54b, 54c, 54d, 54e. The chosen territories 54 may be highlighted on the display device/input device 16. The predefined areas 52 that are being selected may be highlighted on the display device/input device 16) as the pointer 62 is moved over those areas. It should be noted that the territories are typically distinguished from one another with different colors, rather than with hatching or stippling as illustrated in the figures. However, system 10 can show the different territories and groups of predefined areas 52 in any appropriate fashion and still fall within the scope of the present invention.

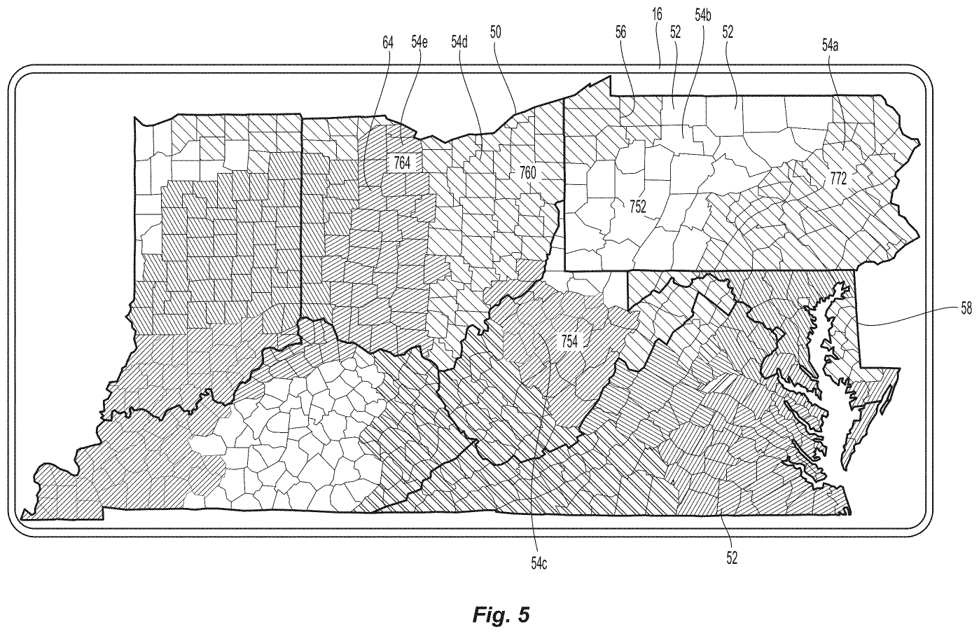

In this example, a function key (generally the control key or some other assigned key in the system 10) may be pressed during the selection of the sales territories 54. The territory balancing system 40 is waiting at S107 until the user releases the pointer 62. At step 109, the territory balancing system 40 determines if the user was pressing the control button at the time of the release of the mouse. If the control button had been pushed, the territory balancing system 40 moves to step S111, but if not, then the territory balancing system 40 moves to step S113. At step S111, the territory balancing system 40 checks to see if a balancing of sales territories had been done previously. If so, then the territory balancing system 40 moves to step S115, where the plurality of sales territories 54 are balanced using the previous balancing criteria. If the control button was not pressed in step S109 or there was not a prior balancing using balancing criteria, the territory balancing system 40 asks the user to select balancing criteria at step S113. Once the balancing criteria is selected at step S113, the territory balancing system 40 automatically balances the selected sales territories. See FIG. 5. Alternatively, the territory balancing system 40 may require an input of the balancing criteria each time.

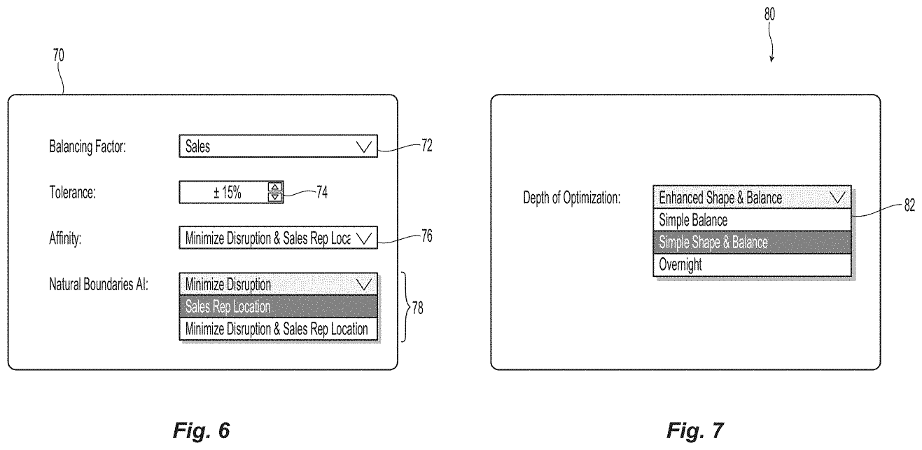

The balancing criteria that can be used to balance the sales territories includes, but is not limited to, sales volume, number of sales calls, the number of accounts, the number of territories, and the compactness of the sales territories. It may also consider the location of the sales representatives in each of the sales territories and whether there are any limitations on the size or shape of the sales territories. Illustrated in FIG. 6 is a dialog box 70 that may be used with the territory balance system 40 to select the balancing criteria in box 72 (which may have drop-down menu to provide the various balancing criteria). The territory balancing system 40 and box 74 in particular may also allow the user to specify a predetermined range within which values in each of the sales territories may differ. For example, the territories illustrated in FIG. 5 have sales of 764, 760, 754, 752 and 772 based on a range of ±15%. These numbers would obviously change based on the balancing criteria. For example, each of the sales territories would have radically different numbers for the sales volume versus the number of accounts. Thus, the user may be able to choose a smaller range for the number of accounts than for the sales volume. The range may be greater than or less than ±15%. For example, the range should be much less than ±50% and even less than ±30%. Ranges less than ±15%. may be difficult to achieve depending upon the balancing criteria.

The user may also use the box 76 to choose the affinity or the way the territory balance system 40 tries to create the balance. The box 76 also has a drop-down menu 78 that allows the user to select one of 1) minimizing the disruption of the current sales territories, 2) balancing the sales territories about where the sales representative are stationed (or some other geographical location), or 3) both.

Next the user may also have input with regard to the depth of the balancing of the sales territories using the second dialog box 80 in FIG. 7. The choices in the selection box 82 affect how hard the algorithm or the territory balance system 40 works to achieve the balancing criteria, including the number of iterations and time that the territory balance system 40 works on balancing. The drop-down menu 82 provides choices of a simple balance (a basic balancing), simple shape and balance (where the shapes of the territories and the perimeters of the sales territories are smaller; and overnight (works hard to accommodate all of the criteria).

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

I claim:

1. A sales territory balancing system comprising:
at least one computer processor;
a display coupled to the at least one computer processor;
an input device for communication with the at least one computer processor and the display; and
a memory coupled to the at least one computer processor, the sales territory balancing system is configured for:
displaying on the display a geographic area, the geographic area comprising a plurality of predefined areas, and the geographic area is also divisible into a plurality of sales territories, wherein each of the plurality of sales territories includes a plurality of the predefined areas; and
adjusting at least some of the plurality of sales territories in response to a user selecting a first sales territory with a pointer and then moving the pointer through a plurality of sales territories to another portion of the geographic area, whereby the plurality of sales territories pointed to by the user are automatically balanced based on at least one balancing criteria to create a group of balanced territories after selection of the plurality of the sales territories.

2. The sales territory balancing system according to claim 1, wherein the at least one balancing criteria includes sales volume, number of sales calls, the number of accounts, the number of territories, and the compactness of the sales territories.

3. The sales territory balancing system according to claim 1, wherein the each of the sales territories in the group of balanced territories has a value based on the at least one balancing criteria and the values of each of the sales territories in the group of balanced territories are within a predetermined range.

4. The sales territory balancing system according to claim 3, wherein the predetermined range is ±50%.

5. The sales territory balancing system according to claim 3, wherein the predetermined range is between ±10 and ±30%.

6. The sales territory balancing system according to claim 1, wherein the predefined areas correspond to areas selected from the group of postal codes, zip codes, telephone area codes, county boundaries, municipal boundaries, and congressional boundaries.

7. The sales territory balancing system according to claim 1, wherein the at least one balancing criteria is used in a subsequent balancing of territories when a predetermined key associated with the at least one computer processor is selected during the movement of the pointer.

8. The sales territory balancing system according to claim 5, wherein the predetermined key is the control key.

9. The sales territory balancing system according to claim 1, wherein the display is a touch screen and the pointer is a finger.

10. The sales territory balancing system according to claim 1, wherein the pointer is a cursor.

11. The sales territory balancing system according to claim 1, wherein the system is further configured for saving information about each of the sales territories in the group of balanced territories.

12. The sales territory balancing system according to claim 1, wherein the adjusting of the plurality of sales territories uses balancing technology.

13. The sales territory balancing system according to claim 1, wherein information about each of the sales territories in the group of balanced territories are delivered to sales associates to service each of the sales territories in the group of balanced territories.

14. A method of balancing sales territories comprising:
selecting at least one of a plurality of predefined areas with a pointer on a display coupled to at least one computer processor, the plurality of predefined areas being located in a geographic area and wherein the geographic area is also divisible into a plurality of sales territories and each of the plurality of sales territories includes a plurality of the predefined areas; and
moving the pointer within the geographic area from a first sales territory in the plurality of sales territories through the geographic area to select a group of sales territories, wherein the group of selected sales territories selected by the user are automatically balanced based on at least one balancing criteria to create a group of balanced territories after selection of the sales territories.

15. The method according to claim 14, wherein the at least one balancing criteria is selected from a group comprising sales volume, number of sales calls, the number of accounts, the number of territories, and the compactness of the sales territories.

16. The method according to claim 14, wherein the each of the sales territories in the group of balanced territories has a value based on the at least one balancing criteria and the values of each of the sales territories in the group of balanced territories are within a predetermined range.

17. The method according to claim 14, wherein the predetermined range is between ±10 and ±30%.

18. The method according to claim 14, wherein the at least one balancing criteria is used in a subsequent balancing of territories when a predetermined key associated with the at least one computer processor is selected during the movement of the pointer.

19. The method according to claim 18, wherein the predetermined key is the control key.

20. The method according to claim 14, wherein the adjusting of the plurality of sales territories uses balancing technology.
